(19) United States
(12) Patent Application Publication
(10) Pub. No.: US 2021/0049440 A1
(43) Pub. Date: Feb. 18, 2021

(54) SMART COACH FOR ENHANCING PERSONAL PRODUCTIVITY

(71) Applicant: Microsoft Technology Licensing, LLC, Redmond, WA (US)

(72) Inventors: Robert A. SIM, Bellevue, WA (US); Nirupama CHANDRASEKARAN, Seattle, WA (US); Omar SHAYA, Berlin (DE); Sujay Kumar JAUHAR, Kirkland, WA (US); Ryen W. WHITE, Woodinville, WA (US)

(73) Assignee: Microsoft Technology Licensing, LLC, Redmond, WA (US)

(21) Appl. No.: 16/543,357

(22) Filed: Aug. 16, 2019

(51) Int. Cl. G06N 3/00; G06F 9/451; G06Q 10/06

(52) U.S. Cl. CPC G06N 3/004; G06N 20/00; G06Q 10/06313; G06F 9/453

(57) ABSTRACT

Aspects of the present disclosure relate to a smart coach for optimizing an ordering of tasks. In examples, a plurality of tasks associated may be received by the smart coach. In some instances, the plurality of tasks may be for one or more users. Task related information associated with at least one optimization criterion may be received at a user interface or retrieved from storage. An ordering of the plurality of tasks with respect to the at least one optimization criterion may then be generated, where the at least one optimization criterion may be based on at least one of a user optimization goal, an efficiency goal, and a task priority level. The optimized ordering of tasks may then be displayed at a user interface in a task execution order. In some examples, the ordering of tasks may be displayed as an agenda and/or in a calendar view.

### BACKGROUND

A task management solution enables users to track various tasks. A user may prefer to complete a task in any of a variety of different ways in view of one or more constraints. However, determining the optimal way to complete a task in view of such constraints is difficult, especially when considering multiple constraints. For example, users may struggle to prioritize tasks, struggle with too many tasks, struggle with procrastination of important tasks, and have difficulty taking first steps on tasks. While users generally want to be more productive, some of the above obstacles often stand in their way.

It is with respect to these and other general considerations that embodiments have been described. Also, although relatively specific problems have been discussed, it should be understood that the embodiments should not be limited to solving the specific problems identified in the background.

### SUMMARY

Examples of the present disclosure describe systems and methods for implementing a smart coaching task management system for modifying task, or goal, placement to assist a user in completing the goal in an optimal manner. To complete a task optimally may depend on user and task circumstances. For example, an optimization of task may be based on but is not limited to, task/event dependencies (for example, one task may depend on the completion of another task), a user optimization goal (for example, providing an order of tasks that achieves a highest amount of user happiness), an efficiency goal (for example, providing an order of tasks/events where the tasks/events having a large degree of mental difficulty are spaced apart from one another may optimize an efficiency; alternatively, providing an order of tasks/events where the tasks/events having a large degree of mental difficulty are close to one another may optimize an efficiency), task/event priorities (for example, tasks having a higher priority may be completed before tasks having lower priorities), and combinations thereof. Accordingly, a smart coach may be utilized to understand users' tasks and help them decompose, purge, and prioritize their tasks into manageable daily, weekly and monthly agendas, while ensuring daily progress towards long-term goals. In accordance with some aspects of the present disclosure, the smart coaching task management system may solicit user input on task importance, task difficulty/complexity, and a user's emotional valence with respect to the task. The system may proactively prompt the user to delete tasks that are not important, have lingered on the to-do list for a long time, and/or have low probability of ever being completed. In some instances, the system may generate an agenda for the day or other time-span of interest, to assist a user in completing a goal or task in an optimized manner. In one non-limiting example, the system may attempt to maximize productivity, promote an overall positive emotional disposition to the task list, and attempt to ensure long-term achievement of the more difficult goals.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates details of a smart coach system in accordance with the aspects a of the disclosure;

FIG. 2 depicts additional details of the smart coach system in accordance with examples of the present disclosure;

FIG. 3 depicts details of a first component of the smart coach system in accordance with examples of the present disclosure;

FIG. 4 depicts details of a second component of the smart coach system in accordance with examples of the present disclosure;

FIG. 5 depicts additional details of a first graphical user interface in accordance with examples of the present disclosure;

FIG. 6 depicts details of a third component of the smart coach system in accordance with examples of the present disclosure;

FIG. 7 depicts additional details of a second graphical user interface in accordance with examples of the present disclosure;

FIG. 8 depicts additional details of a third graphical user interface in accordance with examples of the present disclosure;

FIG. 9 depicts additional details of a smart coach in accordance with examples of the present disclosure;

FIG. 10 depicts details of a first method in accordance with examples of the present disclosure;

FIG. 11 depicts details of a second method in accordance with examples of the present disclosure;

FIG. 12 depicts details of a data structure in accordance with examples of the present disclosure;

FIG. 13 is a block diagram illustrating example physical components of a computing device with which aspects of the disclosure may be practiced;

FIG. 14A is a simplified block diagram of a computing device with which aspects of the present disclosure may be practiced;

FIG. 14B is another are simplified block diagram of a mobile computing device with which aspects of the present disclosure may be practiced; and

FIG. 15 is a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

A task management application provides functionality that enables a user to manage and track a task to completion. For example, a task may be comprised of a set of subtasks, have one or more associated resources, and/or have other users with which aspects of the task are associated. Thus, it is possible to view progress toward completion of the task, generate an estimated time of completion, and delegate aspects of the task to other users. However, in some examples where tasks may be complex or large, a smart coaching task management application may assist a user to better understand task complexity, suggest decomposing large tasks into smaller more management tasks, and provide prioritization suggestions for tasks in order to maximize productivity and realization of goals.

In accordance with some aspects of the present disclosure, a smart coach is provided that may suggest daily agendas that account for both immediate high-priority tasks as well as incremental progress on longer-term projects, while taking into account other contexts and constraints that can impact the user's ability to act on the tasks. Moreover, such a smart coach may infer users' feelings about a collection of tasks from direct feedback (e.g., likes/dislikes) and also from observations of their behavior (for example repeatedly ignoring a task, or prioritizing other low priority tasks when there exists a bigger, higher priority task that is scheduled). In some examples, the smart coach may actively solicit feedback during the prioritization process, aiming to understand task importance and a user's likelihood to procrastinate. Thus, the smart coach may adapt coaching styles based on user progress and/or user preferences and further provide a user with an aggregate view of their productivity and progress towards productivity and task optimization goals.

In some aspects, the smart coach may deliver metrics to assist a user in measuring their productivity/progress relative to other users and further provide timely notifications to help users stay on task, or complete tasks relevant to a time or location. More specifically, the smart coach may utilize a task list to solicit user input on the task importance, task difficulty/complexity, and emotional valence with regard to the task (does the user feel good or bad about having to do the task). Thus, given enough user input, possibly across many users, the smart coach system may learn to accurately predict the responses provided in the user feedback. The smart coach system may collect additional input from users to refine/break down tasks that are difficult or have negative emotional valence, yielding smaller subtasks that users can grapple with. In addition the system may proactively prompt the user to delete tasks that are not important, have lingered on the to-do list for a long time, and/or have low probability of ever being completed. The system may generate an agenda for the day or other time-span of interest to assist the user in optimizing task completion by maximizing productivity, promoting an overall positive emotional disposition to the task list, and ensuring long-term achievement of the more difficult goals for example. The system may subsequently follow up with the user to determine which tasks were accomplished, re-assess the user's emotional disposition towards their open and completed tasks, add any new tasks, and update the agenda. The system may collaborate with the user to identify incentives for completing a task (explicit rewards like grabbing a treat on a dreaded shopping trip) and/or pre-visualizing successful completion of the task

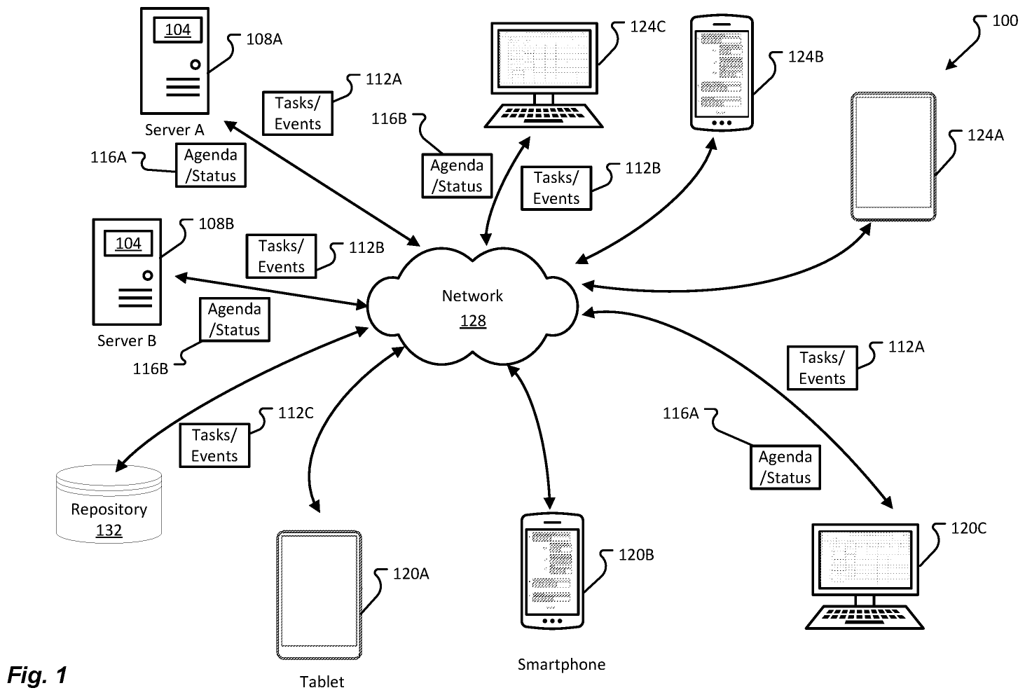

FIG. 1 depicts aspects of a smart coach system 100 for improving productivity of one or more users in accordance with examples of the present disclosure. In some examples, the smart coach system 100 may include a smart coach 104 running on or otherwise being executed at one or more servers 108A/108B. The smart coach 104 may be configured to receive one and/or more tasks or events 112A/112B/112C via one or more networks, such as network 116, process the one or more tasks or events 112A/112B/112C, and provide an agenda and/or task status 116A/116B to one or more users and/or one or more user devices 120A-C/124A-C via a network 128, where the agenda and/or task status 116A/116B may indicate an order of task performance, a period of time associated with a task and/or event (such as a calendar entry for example), and/or a status associated with a task and/or event (such as an amount of one or more tasks that have been completed). In some examples, the user devices 120A-C/124A-C may correspond to a tablet 120A/124A, a smartphone 120B/124B, and/or a client device 120C/124C. As another non-limiting example, at least one user device 120A-C/124A-C may be any device configured to allow a user to use an application such as, for example, a smartphone, a tablet computer, a desktop computer, laptop computer device, gaming devices, media devices, smart televisions, multimedia cable/television boxes, smart phone accessory devices, industrial machinery, home appliances, thermostats, tablet accessory devices, personal digital assistants (PDAs), or other Internet of Things (TOT) devices. Such application may determine or otherwise obtain one or more tasks to be completed and provide such tasks to be completed to the smart coach 104; in some instances, the smart coach 104 may provide a reminder or other notification to the at least one user device 120A-C/124A-C.

The user devices 120A-C/124A-C may be specific to one or more users. For example, a first user may utilize user devices 120A-C while a second user may utilize user devices 124A-C. As illustrated in FIG. 1, one or more tasks/events 112A may be provided from one or more user devices 120A-120C. The one or more tasks/events 112A may be associated with a first user. As further illustrated in FIG. 1, one or more tasks/events 112B may be provided from one or more user devices 124A-124C. The one or more tasks/events 112B may be associated with a second user. Each of the tasks/events 112A and/or 112B may be provided to a smart coach 104 via the network 128. In some examples, the tasks/events may be a list of tasks and/or events and one or more tasks/events 112A/112B/112C may correspond to a task, such as a reminder, entered into one or more applications. In some examples, one or more tasks/events 112A/112B/112C may correspond to a task and/or obligation that is derived and/or inferred from text content, email content, audio content, and/or video content from one or more sources. As one example, an obligation to perform a task and/or an amount of time or target date to perform such task may be inferred from an email between two participants. In some examples, the tasks/events 112A/112B/112C may correspond to an event, such as a calendar entry which may reserve or otherwise exclude one or more periods of time from being scheduled for task completion. In some instances, the smart coach 104 may receive one or more tasks/events 112C from a repository 132 storing one or more tasks and/or events. For example, the repository 132 may store one or more tasks and/or events derived and/or inferred from text content, email content, audio content, and/or video content from one or more sources; thus, the repository 132 may provide one or more tasks/events to the smart coach 104, where each task and/or event may be associated with one or more users.

The smart coach 104 may receive one or more of the tasks/events 112A/112B/112C and determine or otherwise generate an agenda specific to a user, group of users, and/or user device based on one or more optimization parameters. For example, the smart coach 104 may receive a plurality of tasks/events 112A/112B/112C specific to one or more users; the smart coach 104 may then process the plurality of tasks/events 112A/112B/112C to generate an agenda and/or task status specific to each user, a plurality of users, and/or a user device. The agenda and/or task status 116A/116B may include an order of tasks to be completed and/or specific periods of time, such as time slots or time-spans, for each of the tasks. In some examples, the smart coach 104 may process the one or more tasks/events 112A/112B/112C based on additional task/event information provided by a user. For example, a user may provide additional information about a task which may include, but is not limited to, task difficulty, a task importance, an estimated amount of time needed to perform the task, and/or a user's emotional valence towards a task (that is, does the user feel good or bad about having to do the task). In some instances, the smart coach may solicit information from one or more users to determine the additional information about the task. In some examples, the smart coach 104 may predict such additional information. In some instances, the additional information may be specific to one or more of the user devices 120A-C/124A-C with which the user is currently interacting with or predicted to interact with.

Utilizing the one or more task/events 112A/112B/112C, the smart coach 104 may generate an agenda/status 116A/116B to be provided to the user. The agenda/status 116A/116B may be specific to a period of time and/or a time-span of interest and may be tailored to maximize productivity, promote an overall positive emotional disposition for a list of tasks (for example, attempt to ensure a user remains or is happy while completing one or more tasks), and ensure long-term achievement of one or more difficult goals or tasks. In some examples, the smart coach 104 may collect additional input from users to refine/break down tasks that are difficult or have a negative emotional valence, yielding smaller subtasks that users can grapple with; accordingly, the agenda/status 116A/116B may include such smaller tasks. As previously mentioned, an agenda of tasks may be provided that is specific to a user device 120A-C/124A-C. For example, a task, such as responding to a short email, that has been shown to be, indicated to be, or otherwise includes a task that can be performed on a mobile device such, as a smartphone, may be scheduled or otherwise associated with a period of time in which the user is away from a desktop device, such as when a user is traveling from one destination to another. In some instances, the agenda provided by the smart coach 104 may be revised and/or updated based on one or more factors, such as but not limited to a user's location, a user's device, a time of day, and/or a perceived or indicated emotional disposition of a user.

In accordance with some examples of the present disclosure, the smart coach 104 may provide a status of each task, and/or subtask, to a user. For example, a status, such as not-completed, completed, percent completed, etc. may be provided to the user as part of an agenda or task list item. The user may be responsible for updating the status, such as whether the task is completed and/or a percentage of the task completed; in some examples, the smart coach may determine or otherwise receive a determination as to how much of a task has been completed. The smart coach 104 may subsequently follow up with the user to determine which tasks were accomplished, re-assess the user's emotional disposition towards their open and completed tasks, add any new tasks, and update the agenda. Moreover, the smart coach 104 may collaborate with the user to identify incentives for completing a task, such as explicit rewards like grabbing a treat on a dreaded shopping trip and/or pre-visualizing successful completion of the task. In some examples, the smart coach 104 may proactively prompt the user to delete tasks that are not important, have lingered on a to-do list for a long time, and/or have a low probability of ever being completed.

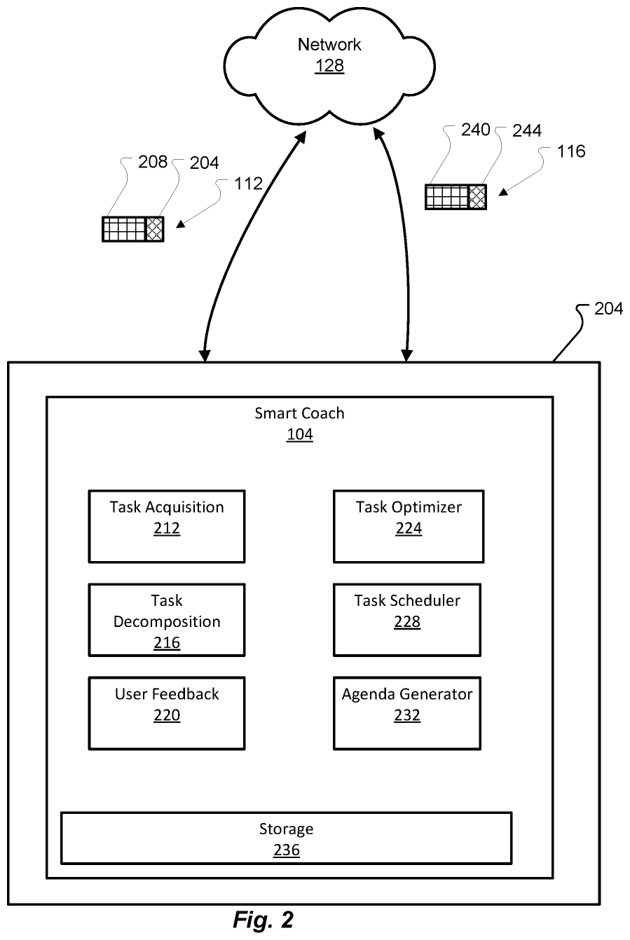

FIG. 2 provides additional details of the smart coach 104 in accordance with examples of the present disclosure. More specifically, the smart coach 104 may include a task acquisition module 212, a task decomposition module 216, a user feedback module 220, a task optimizer module 224, a task scheduler module 228, and an agenda generator module 232. The task acquisition module 212 may receive task/event information 112 as previously discussed. That is, the task acquisition module 212 may receive task/event information 112 from one or more sources, such as a user device 120A-C/124A-C, and/or a repository 132. The task/event information 112 may include header information 204 uniquely identifying the task/event and task/event detail information 208. The task/event detail information 208 may include information specific to the task, such as but not limited to a user associated with the task or event, a task or event type, a task or event name, a task/event importance or priority level, a task/event completion status, a user valence associated with the task/event, task/event difficulty information, relationship information between one or more tasks/events and other task/events (such as whether a task is a subtask of another task), and an estimated amount of time to complete the task. In some instances, the smart coach 104 may determine some or all task/event detail information 208 or some or all of the task/event detail information 208 may be provided by the user. The task/event information 112 may be stored in the storage 236.

The task decomposition module 216 may receive the task/event information 112 from the task acquisition module 212 and/or the storage 236 and determine whether the task, and in some instances an event, may be decomposed into one or more subtasks or one or more sub-events. Accordingly, the task decomposition module 216 may understand task complexity and suggest decomposing large tasks or large events into more manageable subtasks or sub-events and further provide prioritization suggestions for tasks/events in order to maximize productivity and realization of goals. The task decomposition module 216 may determine that a task can be decomposed into one or more subtasks and/or that an event can be decomposed into one or more sub-events based on one or more task/event template matching techniques, one or machine learning techniques, and combinations thereof. In some instances, the task decomposition module 216 may utilize user feedback provided in the task/event detail information 208 to determine wither the task or event is decomposable. Accordingly, the user feedback module 220 may solicit information from a user. As previously discussed, the solicited information may include, but is not limited to, task/event difficulty, task/event importance, an estimated amount of time needed to perform the task/event, and/or a user's emotional valence towards a task/event (that is, does the user feel good or bad about having to do the task/event). The user feedback module 220 may also solicit, from a user, a completion status of a task or event and further provide encouraging feedback to the user once a task or event has been completed or the user has reached certain level of completion of the task or event. For example, the completion status may correspond to a percent complete, a completeness of one or more subtasks, and/or an amount of time spent completing the task.

The task optimizer module 224 may determine, from the acquired tasks, the subtasks resulting from task decomposition, the information obtained by the user feedback module 220, and/or task/event detail information 208, an optimized order of tasks for completion. The smart coach 104 may utilize one or more machine learning techniques and provide such optimization based on but not limited to, task/event dependencies (for example, one task may depend on the completion of another task), a user optimization goal (for example, providing an order of tasks that achieves a highest amount of user happiness), an efficiency goal (for example, providing an order of tasks/events where the tasks/events having a large degree of mental difficulty are spaced apart from one another may optimize an efficiency; alternatively, providing an order of tasks/events where the tasks/events having a large degree of mental difficulty are close to one another may optimize an efficiency), task/event priorities (for example, tasks having a higher priority may be completed before tasks having lower priorities), and combinations thereof. The task scheduler 228 may receive an order of tasks/events from the task optimizer 224 and schedule such tasks in accordance with the order provided by the task optimizer 224. Moreover, the task scheduler 228 may take into account breaks in the day, such as but not limited to work schedules, lunch breaks, productivity breaks, and other events/tasks that may exist in a user's task list or calendar. The agenda generator 232 may generate an agenda for the user, based on scheduled tasks from the task scheduler 228; the agenda generated from the agenda generator 232 may be provided to the user in accordance with a desired task/event list view, such as a day at a time, a week at a time, a Gantt chart, etc. In some instances, the agenda provided by the smart coach 104 may include status information for each task; such information may include but is not limited to a completion amount for each task and an estimated completion goal for the specific task and day. The smart coach 104 may provide the generated agenda to a user device 120A-C/124A-C as an agenda/status 116. The agenda/status 116 may include header information 244 uniquely identifying the task/event and agenda information 240. The agenda information 240 may include information generated by the agenda generator 232. In some instances, the agenda detail information 240 may also include information of the task/event detail information 208.

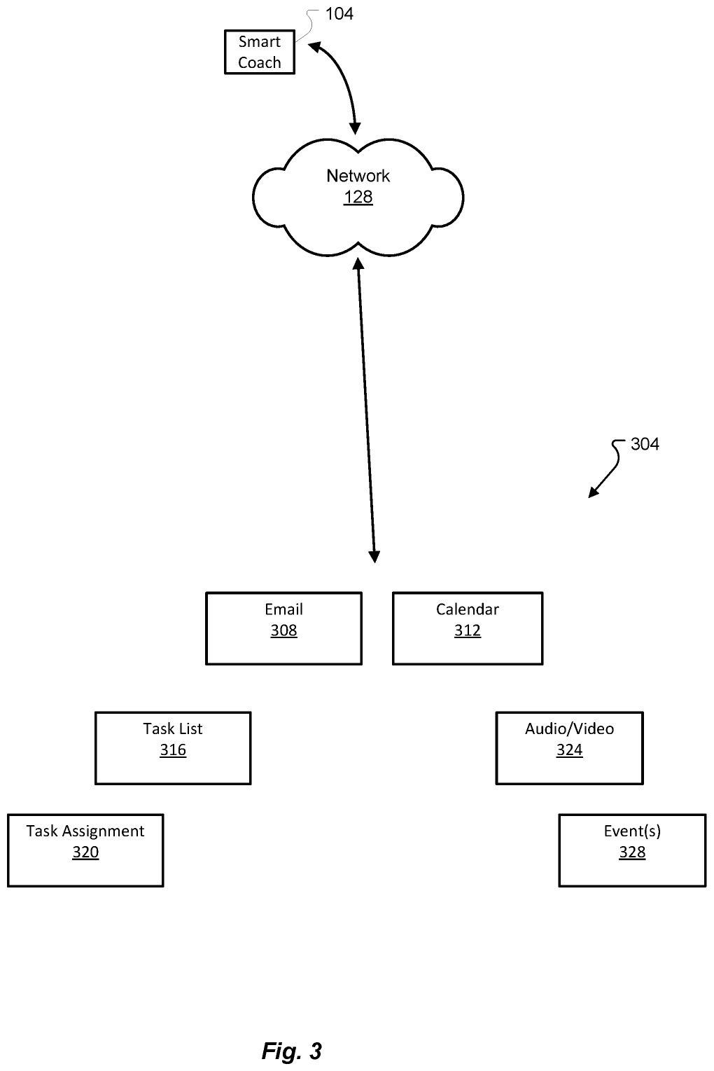

FIG. 3 provides additional details of one or more sources of the tasks/events 304; the smart coach 104 may acquire the tasks/events 304 from one or more devices providing the tasks/events 304, such a user device 120A-C/124A-C. For example, an email 308, calendar 312, and/or a task list 316 may include tasks and/or events that may be consumed by or otherwise provided to the smart coach 104 for decomposition, optimization, and scheduling in accordance with examples of the present disclosure. In some instances, tasks and/or events may be provided from an audio/video source 324. For example, the audio/video source 324 may be a transcript of audio and/or textual information extracted from a video; the audio and/or textual information extracted from the video may be processed such that one or more tasks/events may be extracted and provided to the smart coach 104. In some instances, one or more tasks and/or events may be provided from an event source 328; the event source 328 may coincide with an external source of events that may impact how one or more tasks/events are scheduled. For example, an event indicating that a user has returned from a vacation and/or a specific destination may alter how an order of one or more tasks/events are optimized, scheduled, and/or presented to a user.

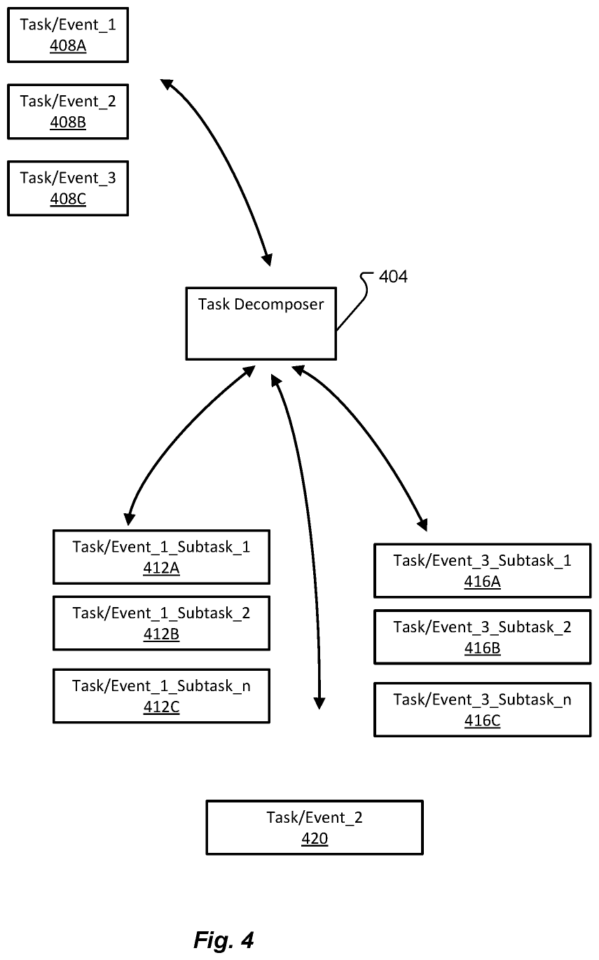

FIG. 4 provides additional details of the task decomposer 404. The task decomposer 404 may be the same as or similar to the task decomposition module 216. The task decomposer 404 may receive one or more tasks or events, such as task/events 408A-C. The task decomposer 404 may then determine whether each task/event 408A-C may be decomposed and if so, the subtasks/sub_events that may result from such decomposition. For example, the task decomposer 404 may receive a first task/event 408A and may determine that such task/event 408A can be decomposed into tasks/events 412A-412C. As another example, the task decomposer 404 may receive a second task/event 408B and may determine that such task/event 408B should not be decomposed into smaller tasks/events; accordingly, the task decomposer 404 may provide, or otherwise not decompose, the second task/event 408B as task/event 420. As another example, task decomposer 404 may receive a third task/event 408C and may determine that such task/event 408C may be decomposed into tasks/events 416A-416C. Such tasks resulting from the task decomposer 404 may be stored in the storage 206 or otherwise made available to one or more modules of the smart coach 104.

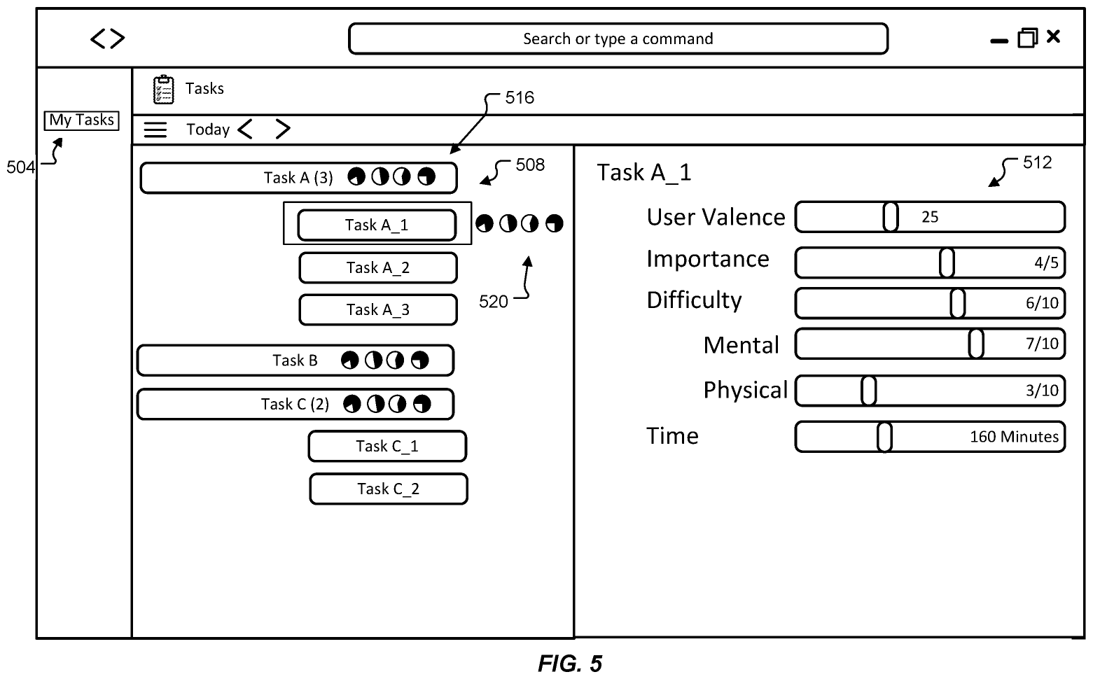

FIG. 5 depicts additional details of an example user interface 504 in accordance with examples of the present disclosure. The example user interface 504 may be provided to a display of a user device 120A-C/124A-C and may be generated by or otherwise based on the user feedback module 220. For example, a user interface 504 may generally provide the ability for a user to visually identify one or more tasks, such as in a task list 508, and provide additional information with respect to each task in a task information area 512. For example, as depicted in FIG. 5, a first task “Task A” may be displayed; the “Task A” may indicate that there are three subtasks “3” and may display the three subtasks upon a user selection or other machine action. A user may further select a first subtask, such as “Task_A_1” and information about “Task_A_1” may be provided in the task information area 512. The task information area 512 may then provide one or more areas to receive task/event information; for example, a user may be able to input or otherwise provide information with respect to, but not limited to, an indication of a user valence, importance, difficulty (mental and physical) and an estimated amount of time for each task/event and/or subtask/sub-event. In addition to displaying the one or more tasks/events and/or subtasks/sub-events, the task list 508 may also display a summary of the information in the task information area 512 as one or graphics, symbols, and/or text 520 for example. Accordingly, a user may be able to discern which tasks/events are difficult, easy, require a lot of time, important, and/or which tasks/event the user is generally excited to complete based on the task list 508. In some instances, a user may add new tasks, delete a task, and/or modify a task utilizing the user interface 504. Further, the information from the task list 508 and/or the task information area 512 may be utilized by the task decomposer 216, task optimizer 224, task scheduler 228, and/or the agenda generator 232 to create or otherwise modify an order of scheduled tasks to be presented to a user as an agenda.

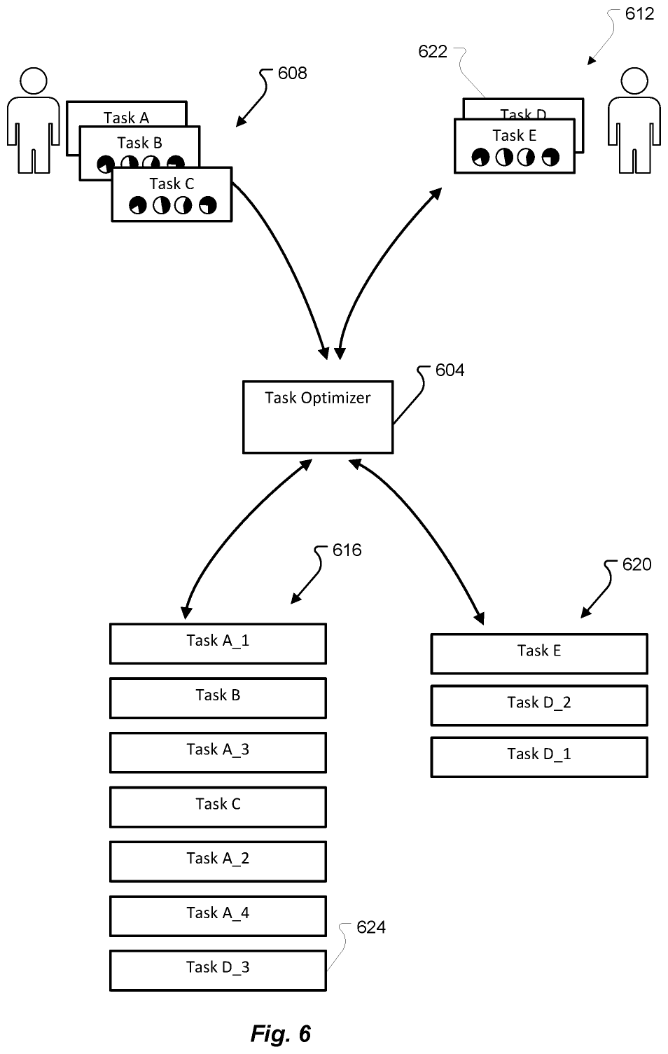

As depicted in FIG. 6, the task optimizer 604 may receive one or more tasks/events 608 from a first user and may generate an optimized order of tasks, such as the order 616. The optimized order of tasks 616 may be based on but not limited to, task/event dependencies (for example, one task may depend on the completion of another task), a user optimization goal (for example, providing an order of tasks that achieves a highest amount of user happiness), an efficiency goal (for example, providing an order of tasks/events where the tasks/events having a large degree of mental difficulty are spaced apart from one another may optimize an efficiency; alternatively, providing an order of tasks/events where the tasks/events having a large degree of mental difficulty are close to one another may optimize an efficiency), task/event priorities (for example, tasks having a higher priority may be completed before tasks having lower priorities), and combinations thereof. As further depicted in FIG. 6, the order of tasks 616 may be arranged and/or modified based on a list of tasks/events 612 from another user. For example, a list task/event 612 may be provided by a second user; a task/event, or subtask/sub-event 622 from a task/event as depicted from a second user is illustrated as being in the first user's optimized order of tasks 616 as 624. Thus, the smart coach 104 may determine that another user is capable of and/or in a better position to perform a task/event or subtask/sub-event; accordingly, the task optimizer 604 may add and/or remove tasks/events and/or subtasks/sub-event to/from one or more user's task lists when determining an optimized order of tasks across a plurality of users. As further depicted in FIG. 6, a second order of tasks 620 may be based on one or more tasks associated with a second user. As illustrated in FIG. 6, the order of tasks 620 may correspond to a different order from which they were originally received.

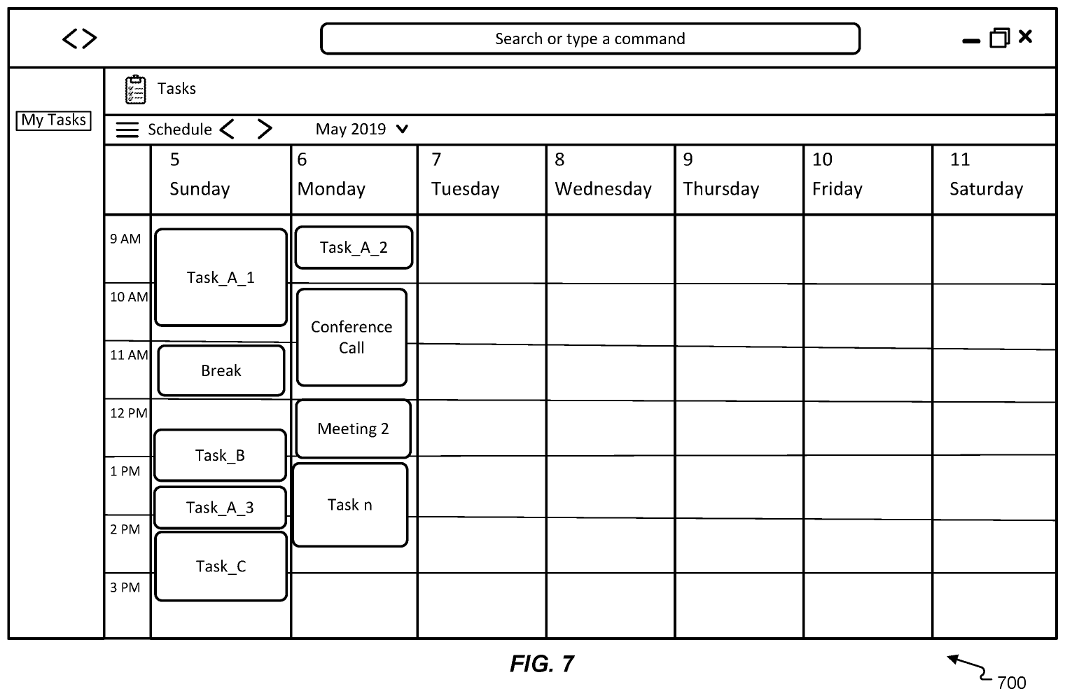

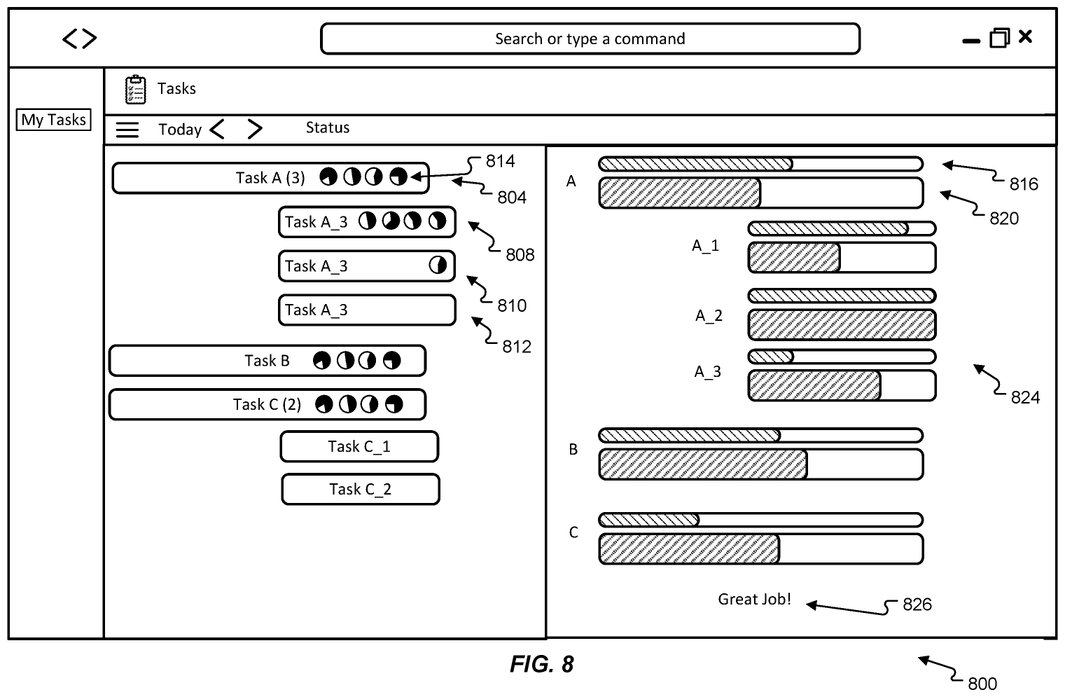

As depicted in FIG. 7, one or more tasks may be scheduled via the task scheduler 228 and presented in a graphical user interface 700. While FIG. 7 depicts tasks arranged and/or scheduled in a graphical user interface 700, such as in a calendar view, such tasks may be presented to a user in other various forms. For example, as depicted in FIG. 8, one or more tasks are presented in a graphical user interface 800 providing an agenda view which may be provided by the agenda generator 232. Accordingly, FIG. 7 and FIG. 8 display one of many various ways one or more tasks may be presented to the user. As further depicted in FIG. 8, one or more tasks may be associated with a particular time slot and/or a specific period of time. For example, Task_A_1 may be associated with a period of time corresponding to Sunday, May 5^{th} between 9:15 AM and 10:45 AM. As further depicted in FIG. 7, the task scheduler 228 may take into account other tasks and/or events that may already exist in a user's schedule. For example, the Meeting 2 may have been an event already on the user's schedule; accordingly, the task scheduler 228 may schedule one or more tasks before and/or or after such event. In some instances, the task scheduler 228 may move or reschedule one more events and/or tasks existing in a user's schedule. The task scheduler 228 may further take into account information, such as order information, from one or more other components of the smart coach 104, for example, from the task optimizer 224. In some instances, the tasks and/or events provided in the calendar view of the graphical user interface 700 may function as a reminder for a user; accordingly, the smart coach 104 may cause such reminders to be output to the graphical user interface 700 for example.

As depicted in FIG. 8, one or more tasks may be provided in an agenda view of a graphical user interface 800 for example. The agenda view may provide a list of one or more tasks, one or more subtasks, and/or one or more events for completion or otherwise interaction with a user. For example, a user may select a task, such as Task A 804, where the selection of Task A 804 may cause one or more subtasks 808, 810, and 812 associated with Task A 804 to be displayed. One or more of the Task A 804, and/or subtasks 808, 810, and 812 may further include a graphical element 814 such that a user may be able to view information with respect to, but not limited to, an indication of a user valence, importance, difficulty (mental and physical) and an estimated amount of time for each task/event and/or subtask/sub-event at a summary level. Alternatively, or in addition, the graphical element 814 may correspond to an amount of the task, or subtask, which is complete. In accordance with examples of the present disclosure, a task information area 824 may provide additional information correspond to one or more tasks; such information may display a graphical element 820 generally indicating an amount of the task that is complete. In some instances, another graphical indicator 816 may provide a baseline, benchmark, and/or other indication informing a user as to an amount or quantity of the task that has been estimated to be complete based on a passage of time. For example, the agenda view may provide an indication as to how far ahead or how far behind the user may be with respect to single tasks, subtask, and/or event. In some instances, a motivational and/or inspirational message 826 may be displayed based on one or more tasks, subtasks, and/or events completed by or otherwise being completed by the user.

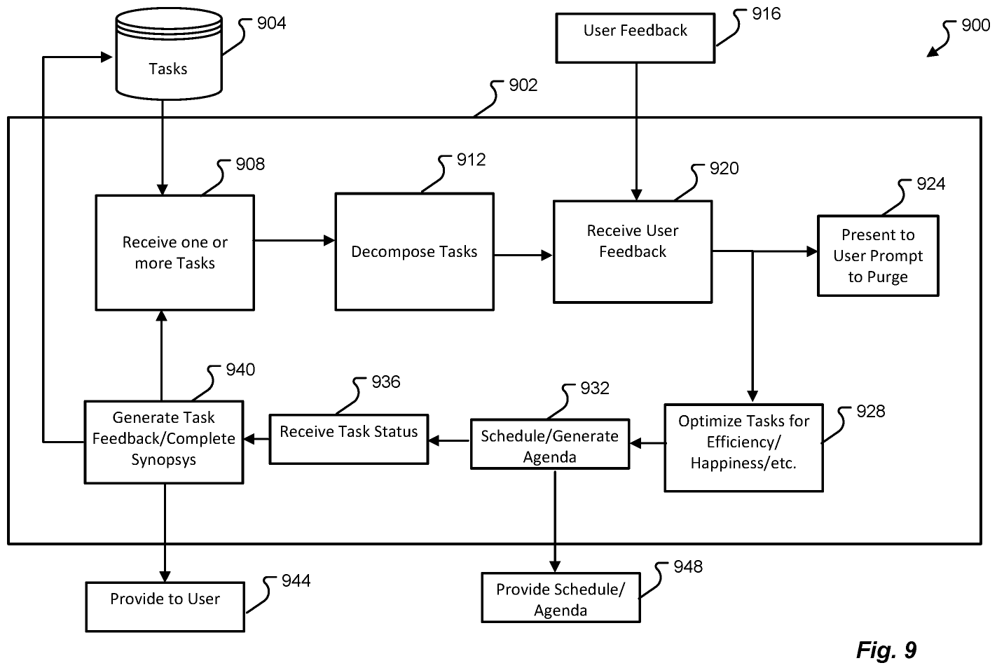

FIG. 9 depicts additional details of a smart coach system 900 in accordance with examples of the present disclosure. More specifically, the smart coach system 900 may be the same as or similar to the smart coach system 100 previously described. The smart coach system 900 may include the smart coach 902, which may be the same as or similar to the smart coach 104 previously described. The smart coach 902 may receive one or more tasks at 908 from a task source and/or task repository 904. The one or more tasks may be analyzed at 912 and may be decomposed into subtasks. For example, a task decomposer 216 may receive a task and determine whether or not such task can be subdivided, or decomposed, into a series of subtasks as previously described. In some instances, user feedback 916 may be received from a user at 920, the user feedback may correspond to, but is not limited to, task/event difficulty, task/event importance, an estimated amount of time needed to perform the task/event, and/or a user's emotional valence towards a task/event (that is, does the user feel good or bad about having to do the task/event). In some instances, the user feedback 916 may be utilized to decompose one or more tasks as previously described. In some examples, a prompt may be provided to a user urging the user to purge one or more tasks at 924. For example, one or more tasks that may be old, non-relevant, and/or have a high likelihood of not being completed may be removed from a list of tasks received at 908.

At 928, an order of the one or more tasks may be optimized for efficiency, happiness, importance, etc. As previously described, an optimized order of tasks may be determined from the acquired tasks, the subtasks resulting from task decomposition, the information obtained from the user feedback, and/or task/event detail information. Accordingly, the smart coach 902 may provide such optimization based on but not limited to, task/event dependencies (for example, one task may depend on the completion of another task), a user optimization goal (for example, providing an order of tasks that achieves a highest amount of user happiness), an efficiency goal (for example, providing an order of tasks/events where the tasks/events having a large degree of mental difficulty are spaced apart from one another may optimize an efficiency; alternatively, providing an order of tasks/events where the tasks/events having a large degree of mental difficulty are close to one another may optimize an efficiency), task/event priorities (for example, tasks having a higher priority may be completed before tasks having lower priorities), and combinations thereof.

At 932, a schedule and/or agenda including the tasks/subtasks that have been optimized may be generated at 932. As previously described, the schedule and/or agenda may correspond to a view of the one or more tasks at a graphical user interface of a device which the user is using. The schedule and/or agenda may be provided to the user at 948. Alternatively, or in addition, task status associated with one or more tasks may be received at 936, where the task status may correspond to an amount of the task that has been completed. At 940, feedback regarding the status of the task and/or subtasks may be generated and provided to a user at 944. As previously described for example, the feedback may include an indication as to a status of each task/subtask and/or task baseline information indicating how far along or approximately how much of the task should be complete. The tasks, in an optimized and/or decomposed order for instance, may then be stored back at the device and/or repository at 904.

The task scheduler 228 may receive an order of tasks/events from the task optimizer 224 and schedule such tasks in accordance with the order provided by the task optimizer 224. Moreover, the task scheduler 228 may take into account breaks in the day, such as but not limited to work schedules, lunch breaks, productivity breaks, and other events/tasks that may exist in a user's task list or calendar. The agenda generator 232 may generate an agenda for the user, based on scheduled tasks from the task scheduler 228; the agenda generated from the agenda generator 232 may be provided to the user in accordance with a desired task/event list view, such as a day at a time, a week at a time, a Gantt chart, etc. In some instances, the agenda provided by the smart coach 104 may include status information for each task; such information may include but is not limited to a completion amount for each task and an estimated completion goal for the specific task and day. The smart coach 104 may provide the generated agenda to a user device 120A-C/124A-C as an agenda/status 116. The agenda/status 116 may include header information 244 uniquely identifying the task/event and agenda information 240. The agenda information 240 may include information generated by the agenda generator 232. In some instances, the agenda detail information 240 may also include information of the task/event detail information 208.

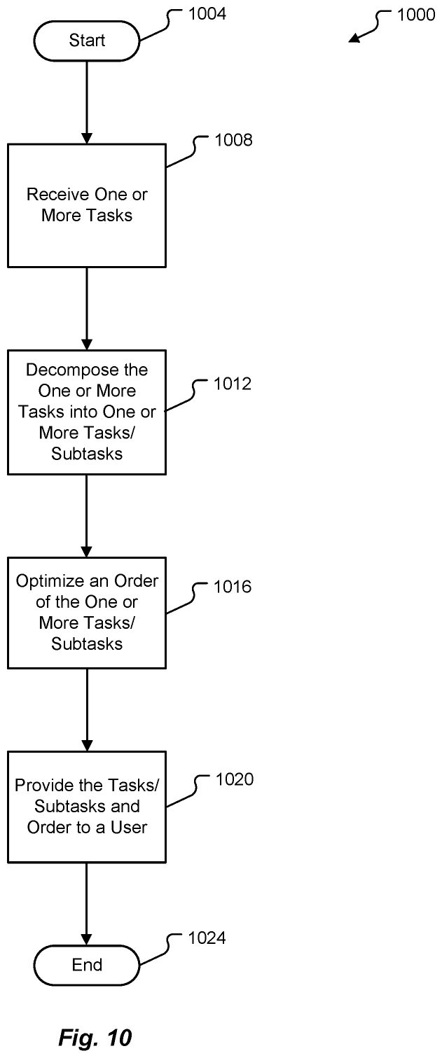

FIG. 10 depicts details of a method 1000 for organizing and presenting one or more tasks to a user in an optimal manner. A general order for the steps of the method 1000 is shown in FIG. 10. Generally, the method 1000 starts with a start operation 1004 and ends with the end operation 1024. The method 1000 may include more or fewer steps or may arrange the order of the steps differently than those shown in FIG. 10. The method 1000 can be executed as a set of computer-executable instructions executed by a computer system and encoded or stored on a computer readable medium. Further, the method 1000 can be performed by gates or circuits associated with a processor, Application Specific Integrated Circuit (ASIC), a field programmable gate array (FPGA), a system on chip (SOC), or other hardware device. Hereinafter, the method 1000 shall be explained with reference to the systems, components, modules, software, data structures, user interfaces, etc. described in conjunction with FIGS. 1-9.

The method 1000 starts at 1004 and proceeds to 1008 where task information associated with one or more tasks is received. The task information may include information specific to the task, such as but not limited to a user associated with the task, a task type, a task name, a task importance or priority level, a task completion status, a user valence associated with the task, task difficulty information, relationship information between one or more tasks and other task (such as whether a task is a subtask of another task), and an estimated amount of time to complete the task. The method 1000 may then proceed to 1012 where one or more tasks may be decomposed into one or more subtasks. In some instances, the smart coach performs the decomposition; in other instances, third party applications and/or task handling procedures may determine that the task can be decomposed into one or more subtasks. The method 1000 may then proceed to 1016 where an order of the tasks and/or subtasks may be determined. In some instances, a task optimizer module may determine, from the acquired tasks, the subtasks resulting from task decomposition, user feedback, and/or other task related information, an optimized order of tasks for completion. For example, such optimization may be based on but not limited to, task/event dependencies (for example, one task may depend on the completion of another task), a user optimization goal (for example, providing an order of tasks that achieves a highest amount of user happiness), an efficiency goal (for example, providing an order of tasks/events where the tasks/events having a large degree of mental difficulty are spaced apart from one another may optimize an efficiency; alternatively, providing an order of tasks/events where the tasks/events having a large degree of mental difficulty are close to one another may optimize an efficiency), task/event priorities (for example, tasks having a higher priority may be completed before tasks having lower priorities), and combinations thereof. The method 1000 may then proceed to 1020 where the order of tasks may be provided to a user. In some instances, the order of tasks may be provided as a calendar view as depicted with respect to FIG. 7; in other instances, the order of tasks may be depicted as an agenda view, as depicted in FIG. 8. Of course, the order of tasks may be presented to a user in a manner different from that which is depicted in FIG. 7 and/or FIG. 8. The method 1000 may then end at 1024.

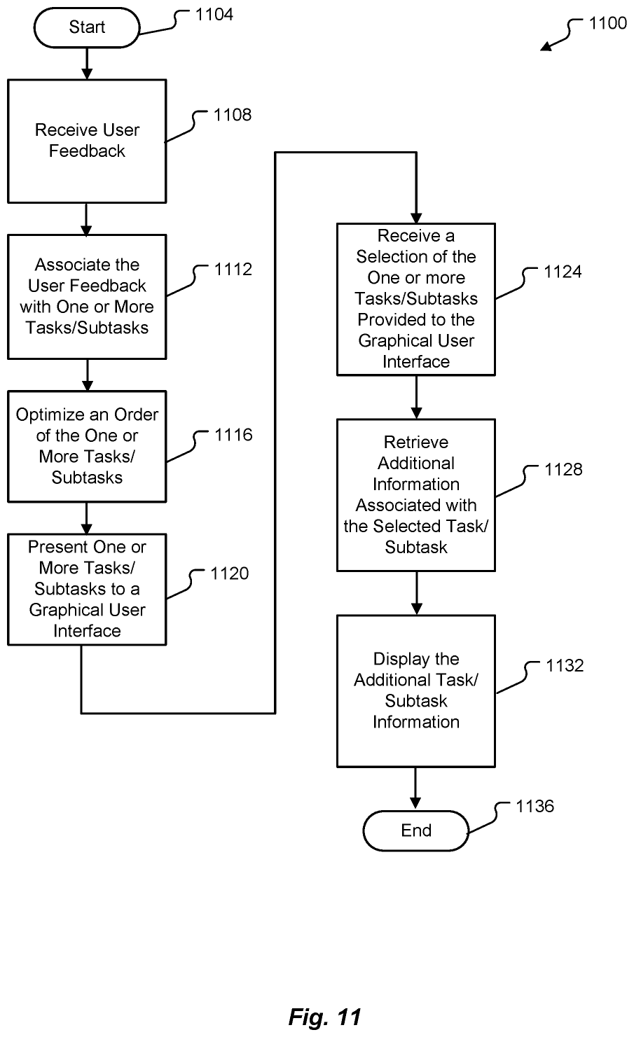

FIGS. 11 depicts details of a method 1100 for receiving user feedback, optimizing an order of tasks to be presented to a user, and then presenting such tasks to a user. A general order for the steps of the method 1100 is shown in FIG. 11. Generally, the method 1100 starts with a start operation 1104 and ends with the end operation 1136. The method 1100 may include more or fewer steps or may arrange the order of the steps differently than those shown in FIG. 11. The method 1100 can be executed as a set of computer-executable instructions executed by a computer system and encoded or stored on a computer readable medium. Further, the method 1100 can be performed by gates or circuits associated with a processor, Application Specific Integrated Circuit (ASIC), a field programmable gate array (FPGA), a system on chip (SOC), or other hardware device. Hereinafter, the method 1100 shall be explained with reference to the systems, components, modules, software, data structures, user interfaces, etc. described in conjunction with FIGS. 1-10.

The method 1100 starts at 1104 and proceeds to 1108 where user feedback associated with a task/subtask may be received. Such user feedback may be provided by a user and may include additional information describing one or more aspects of the task/subtask. For example, the feedback may include but is not limited to task/event difficulty, task/event importance, an estimated amount of time needed to perform the task/event, and/or a user's emotional valence towards a task/event. As previously described, an order of tasks and/or a determination as to which task should be presented when to the user may be determined at 1112, where such determination may correspond to an optimization of the tasks/subtasks in a manner previously described. The method 1100 may proceed to 1120, where one or more tasks/subtasks may be provided to the user.

The one or more tasks/subtasks may be provided to a display of a device associated with the user. For example, a graphical user interface displayed at a display device may display the one or more tasks. As previously described, the tasks/subtasks may be displayed in an agenda view and/or a calendar view. At 1124, a selection of one or more of the tasks/subtasks may be received at the device associated with the user. For example, a user may select a task A 516 displayed in FIG. 5. The selection of the task may cause the task to unroll or otherwise display subtasks, if any, that are associated with the task. If additional associated with the task/subtask is to be displayed along with the agenda or calendar view, then the method 1100 may proceed to 1128 where such information is retrieved. For example, user valence information, importance information, difficulty in terms of one or more of mental and physical, and time may be retrieved to be displayed at a user interface. In some instances, the additional information may include timeslot information associated with the task and/or task/subtask progress information as illustrated in FIG. 8. Such additional information may be displayed at a graphical user interface at 1132. The method 1100 may end at 1136.

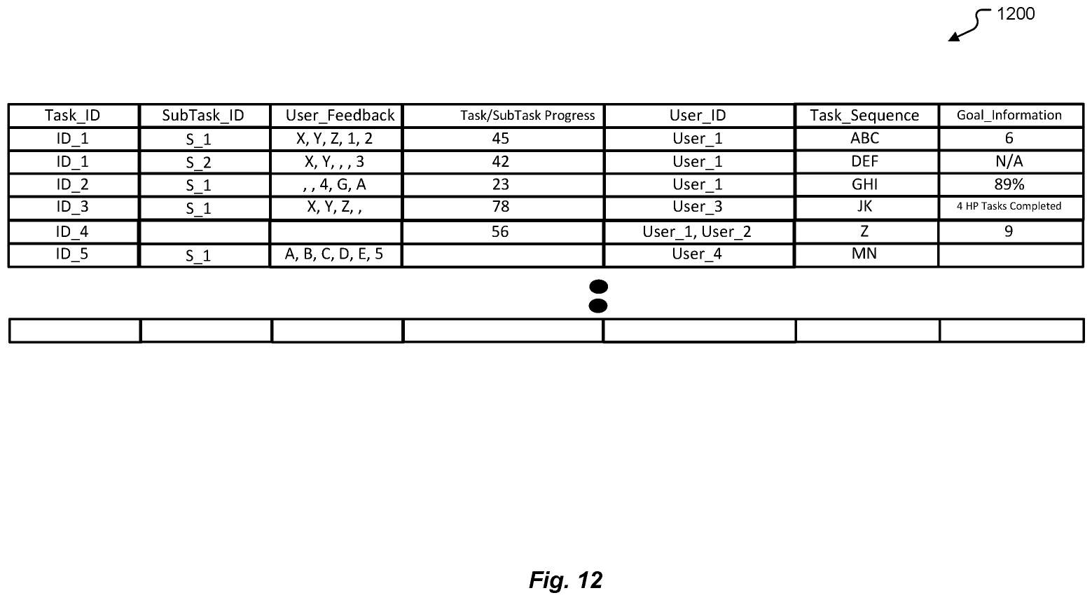

FIG. 12 depicts additional details associated with a data structure 1200 in accordance with examples of the present disclosure. The data structure 1200 may store task related information such as, but not limited to a task identifier, sub task identifier, user feedback, progress associated with the task, a user identifier associated with the task, and task sequence information, if any. The data structure 1200 may be stored as a database and/or stored at a user device, at the smart coach 104 and/or at a storage location, such as the repository 132. The data structure 1200 may be utilized to access information associated with one or more tasks and/or store information associated with the one or more tasks. In examples, one item of data, such as a user identifier, may be utilized to reference or locate another item of information in the data structure. For example, a task identifier may be associated with a user identifier, where the user identifier identifies a user associated with a specific task. In some examples, the data structure 1200 may also include goal information specific to a user and/or group. The goal information may be tracked over time and may be provided to a user. For example, the goal information may indicate that overall, a user is happier—the goal information may indicate that a user is happier when tasks of a specific nature are ordered and/or presented to the user in a specific way. In some examples, the user may provide feedback throughout the task completion process, where the feedback may be specific to one or more overall goals. As another example, the goal may relate to efficiency and/or completing higher priority tasks; the user may provide feedback and/or the smart coach may derive a measurement related to how efficient the user is and/or whether the user is able to complete the higher priority tasks. As another example, the goal information may be associated with a User ID and indicate that user is 89% efficient, feels a 6 on a happiness scale of 1-10, and/or completed 4 high priority tasks. The goal information may be specific to a task and/or tracked per user. The goal related information may be received at and/or displayed at one or more user interfaces previously described, such as Figure and FIG. 8.

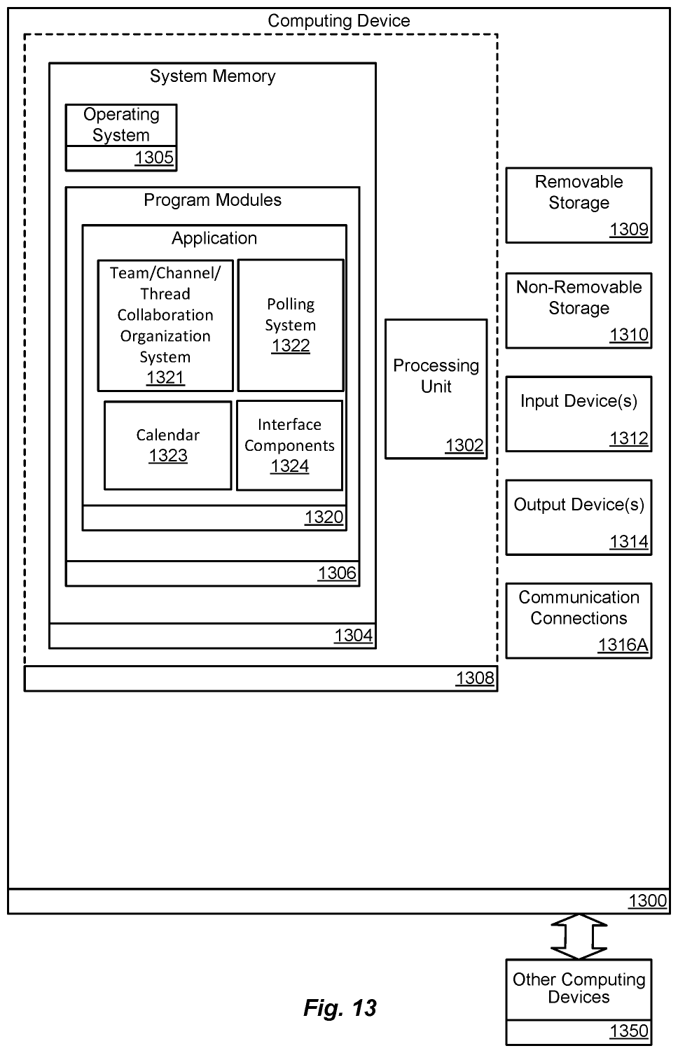

FIG. 13 is a block diagram illustrating physical components (e.g., hardware) of a computing device 1300 with which aspects of the disclosure may be practiced. The computing device components described below may be suitable for the computing devices, such as the client device 116, and/or the smart coach 104, as described above. In a basic configuration, the computing device 1300 may include at least one processing unit 1302 and a system memory 1304. Depending on the configuration and type of computing device, the system memory 1304 may comprise, but is not limited to, volatile storage (e.g., random access memory), non-volatile storage (e.g., read-only memory), flash memory, or any combination of such memories. The system memory 1304 may include an operating system 1305 and one or more program modules 1306 suitable for performing the various aspects disclosed herein such as the smart coach system 1301. The operating system 1305, for example, may be suitable for controlling the operation of the computing device 1300. Furthermore, aspects of the disclosure may be practiced in conjunction with a graphics library, other operating systems, or any other application program and is not limited to any particular application or system. This basic configuration is illustrated in FIG. 13 by those components within a dashed line 1308. The computing device 1300 may have additional features or functionality. For example, the computing device 1300 may also include additional data storage devices (removable and/or non-removable) such as, for example, magnetic disks, optical disks, or tape. Such additional storage is illustrated in FIG. 9 by a removable storage device 909 and a non-removable storage device 1310.

As stated above, a number of program modules and data files may be stored in the system memory 1304. While executing on the processing unit 1302, the program modules 1306 (e.g., one or more applications 1320) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 13 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1300 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 1300 may also have one or more input device(s) 1312 such as a keyboard, a mouse, a pen, a sound or voice input device, a touch or swipe input device, etc. The output device(s) 1314 such as a display, speakers, a printer, etc. may also be included. The aforementioned devices are examples and others may be used. The computing device 1300 may include one or more communication connections 1316A allowing communications with other computing devices 1350. Examples of suitable communication connections 1316A include, but are not limited to, radio frequency (RF) transmitter, receiver, and/or transceiver circuitry; universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1304, the removable storage device 1309, and the non-removable storage device 1310 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1300. Any such computer storage media may be part of the computing device 1300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

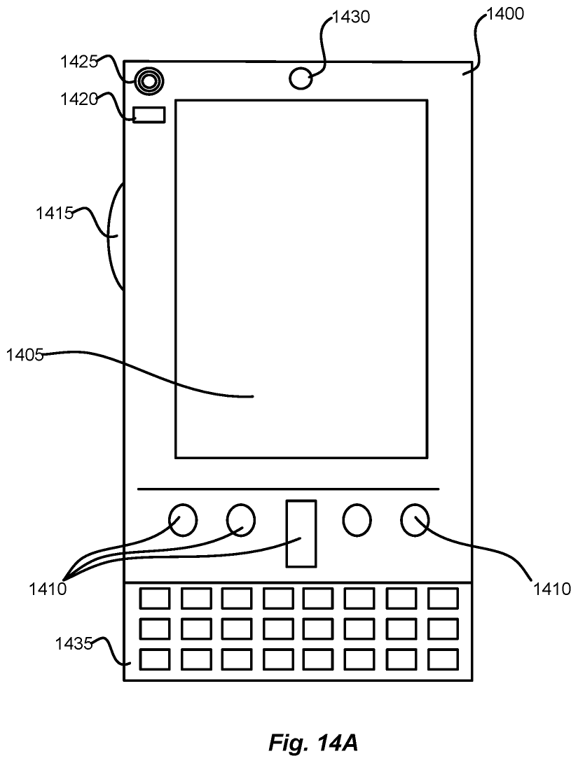

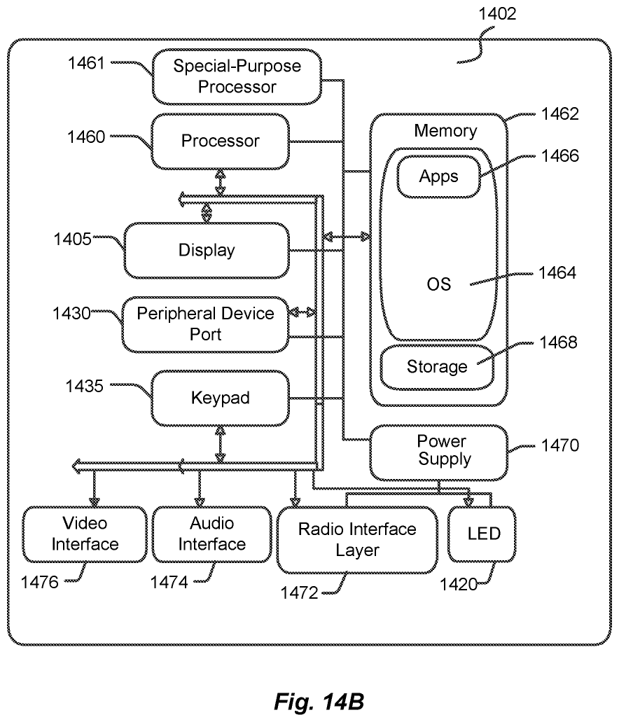

FIGS. 14A and 14B illustrate a computing device, client device, or mobile computing device 1400, for example, a mobile telephone, a smart phone, wearable computer (such as a smart watch), a tablet computer, a laptop computer, and the like, with which aspects of the disclosure may be practiced. In some aspects, the client device (e.g., 116A-116E) may be a mobile computing device. With reference to FIG. 14A, one aspect of a mobile computing device 1400 for implementing the aspects is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. The display 1405 of the mobile computing device 1400 may also function as an input device (e.g., a touch screen display). If included, an optional side input element 1415 allows further user input. The side input element 1415 may be a rotary switch, a button, or any other type of manual input element. In alternative aspects, mobile computing device 1400 may incorporate more or less input elements. For example, the display 1405 may not be a touch screen in some aspects. In yet another alternative aspect, the mobile computing device 1400 is a portable phone system, such as a cellular phone. The mobile computing device 1400 may also include an optional keypad 1435. Optional keypad 1435 may be a physical keypad or a “soft” keypad generated on the touch screen display. In various aspects, the output elements include the display 1405 for showing a graphical user interface (GUI), a visual indicator 1420 (e.g., a light emitting diode), and/or an audio transducer 1425 (e.g., a speaker). In some aspects, the mobile computing device 1400 incorporates a vibration transducer for providing the user with tactile feedback. In yet another aspect, the mobile computing device 1400 incorporates input and/or output ports, such as an audio input (e.g., a microphone jack), an audio output (e.g., a headphone jack), and a video output (e.g., a HDMI port) for sending signals to or receiving signals from an external source.

FIG. 14B is a block diagram illustrating the architecture of one aspect of computing device, a server, or a mobile computing device. That is, the computing device 1400 can incorporate a system (e.g., an architecture) 1402 to implement some aspects. The system 1402 can implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1466 may be loaded into the memory 1462 and run on or in association with the operating system 1464. Examples of the application programs include phone dialer programs, one or more components of the smart coach systems, e-mail programs, personal information management (PIM) programs, word processing programs, spreadsheet programs, Internet browser programs, messaging programs, and so forth. The system 1402 also includes a non-volatile storage area 1468 within the memory 1462. The non-volatile storage area 1468 may be used to store persistent information that should not be lost if the system 1402 is powered down. The application programs 1466 may use and store information in the non-volatile storage area 1468, such as e-mail or other messages used by an e-mail application, title content, and the like. A synchronization application (not shown) also resides on the system 1402 and is programmed to interact with a corresponding synchronization application resident on a host computer to keep the information stored in the non-volatile storage area 1468 synchronized with corresponding information stored at the host computer. As should be appreciated, other applications may be loaded into the memory 1462 and run on the mobile computing device 1400 described herein (e.g., search engine, extractor module, relevancy ranking module, answer scoring module, etc.).

The system 1402 has a power supply 1470, which may be implemented as one or more batteries. The power supply 1470 might further include an external power source, such as an AC adapter or a powered docking cradle that supplements or recharges the batteries.

The system 1402 may also include a radio interface layer 1472 that performs the function of transmitting and receiving radio frequency communications. The radio interface layer 1472 facilitates wireless connectivity between the system 1402 and the “outside world,” via a communications carrier or service provider. Transmissions to and from the radio interface layer 1472 are conducted under control of the operating system 1464. In other words, communications received by the radio interface layer 1472 may be disseminated to the application programs 1466 via the operating system 1464, and vice versa.

The visual indicator 1420 may be used to provide visual notifications, and/or an audio interface 1474 may be used for producing audible notifications via the audio transducer 1425. In the illustrated configuration, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. In accordance with aspects of the present disclosure, the microphone may also serve as an audio sensor to facilitate control of notifications, as will be described below. The system 1402 may further include a video interface 1476 that enables an operation of an on-board camera 1430 to record still images, video stream, and the like.

A mobile computing device 1400 implementing the system 1402 may have additional features or functionality. For example, the mobile computing device 1400 may also include additional data storage devices (removable and/or non-removable) such as, magnetic disks, optical disks, or tape. Such additional storage is illustrated in FIG. 14B by the non-volatile storage area 1468.

Data/information generated or captured by the mobile computing device 1400 and stored via the system 1402 may be stored locally on the mobile computing device 1400, as described above, or the data may be stored on any number of storage media that may be accessed by the device via the radio interface layer 1472 or via a wired connection between the mobile computing device 1400 and a separate computing device associated with the mobile computing device 1400, for example, a server computer in a distributed computing network, such as the Internet. As should be appreciated such data/information may be accessed via the mobile computing device 1400 via the radio interface layer 1472 or via a distributed computing network. Similarly, such data/information may be readily transferred between computing devices for storage and use according to well-known data/information transfer and storage means, including electronic mail and collaborative data/information sharing systems.

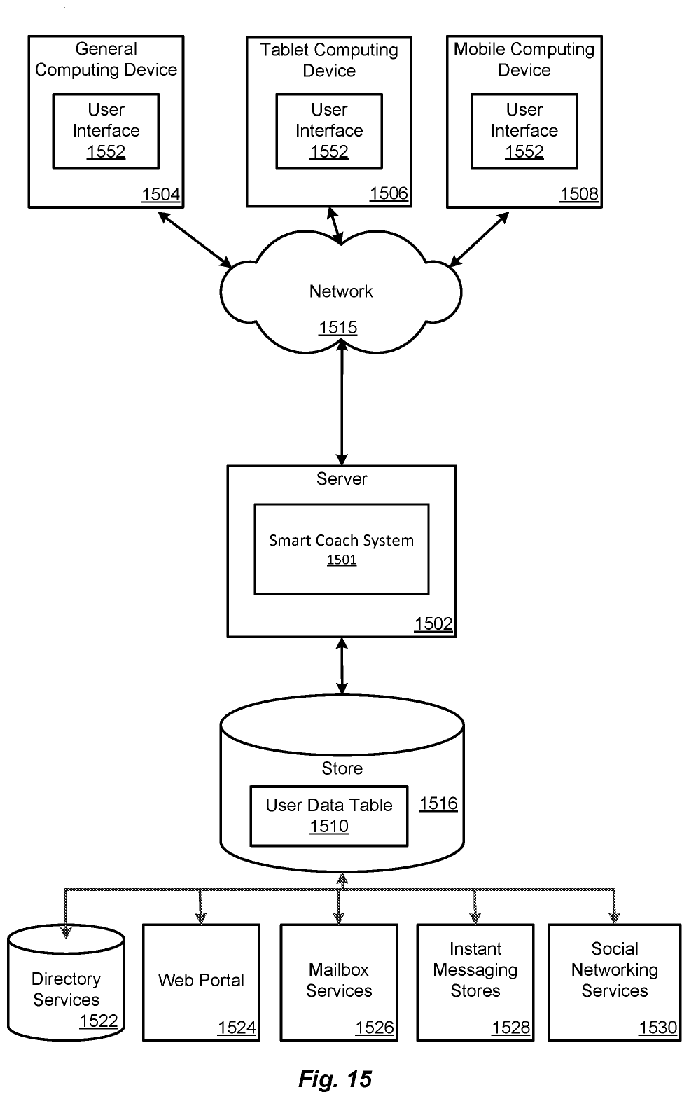

FIG. 15 illustrates one aspect of the architecture of a system for processing data received at a computing system 1502 (e.g., content provider 108) from a remote source, as described above. Content at a server device 1502 may be stored in different communication channels or other storage types. For example, various images, or files may be stored using a directory service 1522, a web portal 1524, a mailbox service 1526, an instant messaging store 1528, or a social networking site 1530. A unified profile API based on the user data table 1510 may be employed by a client that communicates with server device 1502. The server device 1502 may provide data to and from a client computing device such as the client devices 156A-156C through a network 1515. By way of example, the client device 156 described above may be embodied in a personal computer 1504, a tablet computing device 1506, and/or a mobile computing device 1508 (e.g., a smart phone).

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infrared data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

In accordance with at least one example, a system is provided. The system may include at least one processor, and memory storing instructions that, when executed by the at least one processor, causes the system to perform a set of operations. The set of operations may include receiving a plurality of tasks associated with one or more goals, receiving task related information associated with at least one optimization criterion, optimizing an ordering of the plurality of tasks with respect to the at least one optimization criterion and generating an optimized ordering of tasks, and generating a user interface and displaying, in a task execution order, one or more of the plurality of tasks in accordance with the optimized ordering of tasks. At least one aspect of the above system includes receiving a first task of the plurality of tasks, decomposing the first task into a plurality of subtasks, optimizing, with respect to the at least one optimization criterion, an ordering of the plurality of tasks together with the plurality of subtasks, and generating the optimized ordering of tasks including the plurality of subtasks. At least one aspect of the above system includes receiving, at the user interface, a selection of the first task, in response to receiving the selection of the first task, causing the plurality of subtasks to be displayed, receiving a selection of a first subtask of the plurality of subtasks, and displaying task related information associated with the first subtask. At least one aspect of the above system includes displaying at least one graphical element at the user interface, the at least one graphical element indicating at least one of a task status and/or an amount of task completion. At least one aspect of the above system includes retrieving information corresponding to an emotional valence for a first task of the plurality of tasks, and optimizing an ordering of the plurality of tasks based at least upon the emotional valence for the first task of the plurality of tasks. At least one aspect of the above system includes where the plurality of tasks correspond to tasks for a plurality of users, and where the task related information associated with the least one optimization criterion is based on an optimization criterion for a task associated with another user. At least one aspect of the above example includes where the at least one optimization criterion is based on at least one of a user optimization goal, an efficiency goal, and a task priority level. At least one aspect of the above example includes where the at least one optimization criterion is stored in a user profile and the at least one optimization criterion is personalized for the at least one user.

In accordance with at least one example, a method for optimizing an ordering of tasks and subtasks is provided. The method may include receiving a plurality of tasks associated with one or more goals, decomposing a first task of the plurality of tasks into a plurality of subtasks, receiving task related information for each of the plurality of tasks and the plurality of subtasks, the task related information being associated with at least one optimization criterion, optimizing an ordering of the plurality of tasks and subtasks with respect to the at least one optimization criterion, and generating a user interface and displaying, in a task execution order, one or more of the plurality of tasks and subtasks in accordance with the optimized ordering of the plurality of tasks and subtasks. At least one aspect of the above method includes where the one or more of the plurality of tasks and subtasks are displayed as a scheduled ordering of tasks and subtasks in a calendar view, wherein each of the one or more of the plurality of tasks and subtasks are associated with a timeslot. At least one aspect of the above method includes optimizing an ordering of the plurality of tasks and subtasks with respect to the at least one optimization criterion and one or more events displayed in the calendar view. At least one aspect of the above method includes optimizing an ordering of the plurality of tasks and subtasks with respect to the at least one optimization criterion and one or more of a user device, a resource available to the user, a location of the user, and/or a current time. At least one aspect of the above method includes receiving task related information for each of the plurality of tasks and the plurality of subtasks for tasks and subtasks associated with a plurality of users, and optimizing the ordering of the plurality of tasks and subtasks associated with the plurality of users with respect to the at least one optimization criterion. At least one aspect of the above method includes reassigning at least one subtask from a first user to a second user. At least one aspect of the above method includes where the at least one optimization criterion is based on at least one of a user optimization goal, an efficiency goal, and a task priority level.

In accordance with at least one example, a method for optimizing an ordering of tasks is provided. The method may include receiving a plurality of tasks associated with one or more goals, receiving task related information associated with at least one optimization criterion, optimizing an ordering of the plurality of tasks with respect to the at least one optimization criterion and generating an optimized ordering of tasks, and generating a user interface and displaying, in a task execution order, one or more of the plurality of tasks in accordance with the optimized ordering of tasks. At least one aspect of the above method includes receiving a first task of the plurality of tasks, decomposing the first task into a plurality of subtasks, optimizing, with respect to the at least one optimization criterion, an ordering of the plurality of tasks together with the plurality of subtasks, and generating the optimized ordering of tasks including the plurality of subtasks. At least one aspect of the above method includes receiving, at the user interface, a selection of the first task, in response to receiving the selection of the first task, causing the plurality of subtasks to be displayed, receiving a selection of a first subtask of the plurality of subtasks, and displaying task related information associated with the first subtask. At least one aspect of the above method includes where the at least one optimization criterion is provided by a user and is based on at least one of a user optimization goal, an efficiency goal, and a task priority level. At least one aspect of the above method includes where the task related information associated with the at least one optimization criterion is received at the user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving a plurality of tasks associated with one or more goals;
receiving task related information associated with at least one optimization criterion;
optimizing an ordering of the plurality of tasks with respect to the at least one optimization criterion and generating an optimized ordering of tasks; and
generating a user interface and displaying, in a task execution order, one or more of the plurality of tasks in accordance with the optimized ordering of tasks.

2. The system of claim 1, wherein the set of operations further comprises:
receiving a first task of the plurality of tasks;
decomposing the first task into a plurality of subtasks;
optimizing, with respect to the at least one optimization criterion, an ordering of the plurality of tasks together with the plurality of subtasks; and
generating the optimized ordering of tasks including the plurality of subtasks.

3. The system of claim 2, wherein the set of operations further comprises:
receiving, at the user interface, a selection of the first task;
in response to receiving the selection of the first task, causing the plurality of subtasks to be displayed;
receiving a selection of a first subtask of the plurality of subtasks; and
displaying task related information associated with the first subtask.

4. The system of claim 1, wherein the set of operations further comprises:
displaying at least one graphical element at the user interface, the at least one graphical element indicating at least one of a task status and/or an amount of task completion.

5. The system of claim 1, wherein the set of operations further comprises:
retrieving information corresponding to an emotional valence for a first task of the plurality of tasks; and
optimizing an ordering of the plurality of tasks based at least upon the emotional valence for the first task of the plurality of tasks.

6. The system of claim 1, wherein the plurality of tasks correspond to tasks for a plurality of users, and wherein the task related information associated with the least one optimization criterion is based on an optimization criterion for a task associated with another user.

7. The system of claim 1, wherein the at least one optimization criterion is based on at least one of a user optimization goal, an efficiency goal, and a task priority level.

8. The system of claim 7, wherein the at least one optimization criterion is stored in a user profile and the at least one optimization criterion is personalized for the at least one user.

9. A method for optimizing an ordering of tasks and subtasks, comprising:
receiving a plurality of tasks associated with one or more goals;
decomposing a first task of the plurality of tasks into a plurality of subtasks;
receiving task related information for each of the plurality of tasks and the plurality of subtasks, the task related information being associated with at least one optimization criterion;
optimizing an ordering of the plurality of tasks and subtasks with respect to the at least one optimization criterion; and
generating a user interface and displaying, in a task execution order, one or more of the plurality of tasks and subtasks in accordance with the optimized ordering of the plurality of tasks and subtasks.

10. The method of claim 9, wherein the one or more of the plurality of tasks and subtasks are displayed as a scheduled ordering of tasks and subtasks in a calendar view, wherein each of the one or more of the plurality of tasks and subtasks are associated with a timeslot.

11. The method of claim 10, further comprising:
optimizing an ordering of the plurality of tasks and subtasks with respect to the at least one optimization criterion and one or more events displayed in the calendar view.

12. The method of claim 9, further comprising:
optimizing an ordering of the plurality of tasks and subtasks with respect to the at least one optimization criterion and one or more of a user device, a resource available to the user, a location of the user, and/or a current time.

13. The method of claim 9, further comprising:
receiving task related information for each of the plurality of tasks and the plurality of subtasks for tasks and subtasks associated with a plurality of users; and
optimizing the ordering of the plurality of tasks and subtasks associated with the plurality of users with respect to the at least one optimization criterion.

14. The method of claim 13, further comprising:
reassigning at least one subtask from a first user to a second user.

15. The method of claim 14, wherein the at least one optimization criterion is based on at least one of a user optimization goal, an efficiency goal, and a task priority level.

16. A method for optimizing an ordering of tasks, comprising:
receiving a plurality of tasks associated with one or more goals;
receiving task related information associated with at least one optimization criterion;
optimizing an ordering of the plurality of tasks with respect to the at least one optimization criterion and generating an optimized ordering of tasks; and
generating a user interface and displaying, in a task execution order, one or more of the plurality of tasks in accordance with the optimized ordering of tasks.

17. The method of claim 16, further comprising:
receiving a first task of the plurality of tasks;
decomposing the first task into a plurality of subtasks;
optimizing, with respect to the at least one optimization criterion, an ordering of the plurality of tasks together with the plurality of subtasks; and
generating the optimized ordering of tasks including the plurality of subtasks.

18. The method of claim 17, further comprising:
receiving, at the user interface, a selection of the first task;
in response to receiving the selection of the first task, causing the plurality of subtasks to be displayed;
receiving a selection of a first subtask of the plurality of subtasks; and
displaying task related information associated with the first subtask.

19. The method of claim 16, wherein the at least one optimization criterion is provided by a user and is based on at least one of a user optimization goal, an efficiency goal, and a task priority level.

20. The method of claim 16, wherein the task related information associated with the at least one optimization criterion is received at the user interface.
